(19) United States
(12) Patent Application Publication
(10) Pub. No.: US 2010/0318398 A1
(43) Pub. Date: Dec. 16, 2010

(54) NATURAL LANGUAGE INTERFACE FOR COLLABORATIVE EVENT SCHEDULING

(75) Inventors: Caroline Brun, Grenoble (FR); Caroline Hagege, Grenoble (FR)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: Xerox Corporation, Norwalk, CT (US)

(21) Appl. No.: 12/484,569

(22) Filed: Jun. 15, 2009

(51) Int. Cl. G06Q 10/00; G06F 17/27

(52) U.S. Cl. 705/9; 704/9

(57) ABSTRACT

A collaborative event scheduling method and system are provided which allow participants and an event initiator to interact with a scheduler in a natural language form. Participants provide a respective availability announcement, which is processed to generate a representation of the user's availability within a time window specified for the event by the initiator. This includes extracting a temporal expression from the availability announcement, normalizing, if the temporal expression is determined to be referential, identifying an availability modality for each extracted temporal expression from a set of availability modalities. The generated representation is output for establishing a suitable time for the event within the time window based on the availability announcements of the participants.

### BACKGROUND

The exemplary embodiment relates to collaborative scheduling of events. It finds particular application in connection with an on-line scheduling system and will be described with particular reference thereto.

Scheduling of events involving several participants can prove difficult, especially when the event coordinator does not have access to the electronic calendars of all participants. A number of scheduling tools are available for collaboratively scheduling of professional or personal events, such as conference calls, meetings, family reunions, and the like. These tools allow a user to create an event together with a potential timeline. The timeline is generally in the form of a table which shows possible dates/times arranged in time sequence and a list of each of the invited participants or which provides a method for participants to insert their name, which generates a new row of the table. People involved in the event are asked to provide their availabilities on the timeline. The scheduling tool then computes the most popular dates and times for the event, typically displaying the earliest one.

Responding to such a request can prove time consuming for the participants as each one generally has to check their calendar for each of the possible dates and times and identify available time slots. The participant then provides his availability by ticking (or not, in case of unavailability) each potential meeting time that suits him. The scheduling tool may generate a visual representation, showing all the participants and their availabilities for each proposed time period, using color codes to indicate whether or not they are available.

The situation becomes more complex when several meetings are being scheduled over a similar time period, requiring the participants to repeat the process for each event being scheduled. As a result, some participants may ignore the request, hoping that the time identified by the other participants will be convenient. Or, they may telephone or email the event coordinator with a suggested time.

### INCORPORATION BY REFERENCE

The following references, the disclosures of which are incorporated herein in their entireties, by reference, are mentioned:

U.S. Publication No. 2007/0168430, published Jul. 19, 2007, entitled CONTENT-BASED DYNAMIC EMAIL PRIORITIZER, by Caroline Brun, et al., discloses an email organizer which operates in conjunction with an email system and a natural language processor. An action deadline detector detects action deadlines contained in email messages based on syntactic information about the email messages provided by the natural language processor. A scorer assigns priority scores to the email messages based at least on the action deadlines and a current date.

U.S. application Ser. No. 12/046,743, filed Mar. 12, 2008, entitled EVENT EXTRACTION SYSTEM FOR ELECTRONIC MESSAGES, by Xavier Tannier, et al. (hereinafter, Tannier, et al.), discloses detection of dates and named entities within documents and emails to update personal calendars.

U.S. Pub. No. 2003/0177190, entitled METHOD AND APPARATUS FOR INTERACTION WITH ELECTRONIC MAIL FROM MULTIPLE SOURCES, by Paul B. Moody, et al., discloses an electronic mail inbox which uses a mail agent to categorize incoming electronic mail to facilitate more flexible and rapid viewing and possible response thereto.

U.S. Pat. No. 7,058,567, entitled NATURAL LANGUAGE PARSER, by Salah Aït-Mokhtar, et al., discloses a finite state parser which may be utilized in natural language processing.

### BRIEF DESCRIPTION

In accordance with one aspect of the exemplary embodiment, a collaborative event scheduling method includes, for each of a plurality of users, receiving a user's availability announcement in a natural language in response to a collaborative event scheduling request for which a time for an event is to be established within a time window defined by an event initiator, based on the users' availability announcements. Based on the availability announcement, with a computer processor, a representation of the user's availability within the time window is generated, including extracting a temporal expression from the availability announcement, if the temporal expression is determined to be referential, normalizing the extracted temporal expression, identifying an availability modality for each extracted temporal expression from a set of availability modalities, and generating the representation based on the normalized temporal expression and availability modality. The generated representation is output to an event scheduler for establishing a suitable time for the event, within the time window, based on the availability announcements of the users.

In accordance with another aspect, a collaborative event scheduling system includes computer readable memory which stores instructions for receiving a user's availability announcement in a natural language to a collaborative event scheduling request for which a time for the event is to be established within a time period defined by an event initiator, based on the availability announcement, generating a representation of the user's availability within the time period in a format understandable to an associated scheduler, including identifying a temporal expression in the response, normalizing the temporal expression in relation to the time period, identifying an availability modality associated with each identified temporal expression, and generating the representation based on the normalized temporal expression and availability modality, and outputting the representation to an associated scheduler. A processor in communication with the memory executes the instructions.

In accordance with another aspect a collaborative event scheduling method includes receiving an event scheduling request in a natural language form which includes an event for which a time period is to be established within a specified time window. The event scheduling request is processed to identify the time window and a granularity of time periods within the time window. Availability announcements are received from a plurality of invited participants, each availability announcement expressing, in a natural language, the respected participant's availability for the event. Based on the availability announcements, with a computer processor, a representation of each participant's availability within the time window is generated, including extracting a temporal expression from the availability announcement and identifying an availability modality for each extracted temporal expression from a set of availability modalities. A suitable time period for the event within the time window is output, based on the extracted temporal expressions and identified availability modalities for the participants.

### BRIEF DESCRIPTION OF THE DRAWINGS

FIG. 1 is an overview of an exemplary scheduling method;

FIG. 2 illustrates an exemplary environment in which a collaborative event scheduling system in accordance with another aspect of the exemplary embodiment operates;

FIG. 3 illustrates sub-components of a Natural Language Processing (NLP) component of the exemplary event scheduling system of FIG. 2;

FIG. 4 is a flow chart illustrating the method for scheduling an event utilizing the exemplary event scheduling system;

FIG. 5 illustrates steps of processing an initiator announcement (IA) in the exemplar method of FIG. 4;

FIG. 6 illustrates steps of processing an availability announcement (AA) in the exemplary method of FIG. 4;

FIG. 7 illustrates a screenshot of a graphical user interface displaying an event scheduler and a textual response of a user; and

FIG. 8 illustrates another screenshot of the graphical user interface with the event scheduler updated based on a textual response of a user.

### DETAILED DESCRIPTION

The exemplary embodiment relates to an automated event scheduling system enhanced with a natural language processing component and to a method of scheduling an event with such a system. The natural language processing component allows participants to express their availabilities in natural language, e.g., as a sentence expressing their availability within the time frame of a proposed timeline, as an alternative to inserting check marks in a table which shows the timeline with possible dates/times arranged in sequence. The exemplary natural language processing component analyzes the sentences of each participant in order to fill a corresponding participant availability timeline table. In one embodiment, participants express themselves in written language. In other embodiments, a speech analysis system allows verbal interaction with the system.

As used herein, an “electronic message” refers to any message such as an electronic mail message (email), a text message (SMS message), voice over Internet protocol (VOIP) message, or the like, by which text and/or voice messages can be communicated between one computing device and another.

An event scheduling request can take the form of an “initiator announcement” or IA, which is in a natural language (text or spoken words) sent by an event initiator to an event scheduling system and optionally also to the invited participants for purposes of scheduling a suitable time for holding an event. In other embodiments, an event scheduling request may be an automatically generated communication sent by the event scheduling system. In such a case, the event scheduling request may include a calendar of available times which the requested participants can fill in or simply reply with a written or verbal availability announcement. An event scheduling request may include one or more IA's.

An “availability announcement,” or AA, as used herein, is a natural language expression (written or verbal) produced by an event participant (or invited participant) and received by the event initiator/event scheduling system, in response to an event scheduling request or IA. In general, an availability announcement includes one or more temporal expressions (TEs).

A “temporal expression,” as used herein, can be any piece of information that describes a time or a date in the future, such as “today,” “tomorrow,” “on Friday,” “next Thursday,” “every Tuesday,” “in two hours”, “in ten days time,” “all day,” “for the next two weeks,” as well as specific references to dates and times, such as 10.30 a.m., 15:45, on May 16, 2009, January 25^{th}, 21 Mar. 2010, and the like.

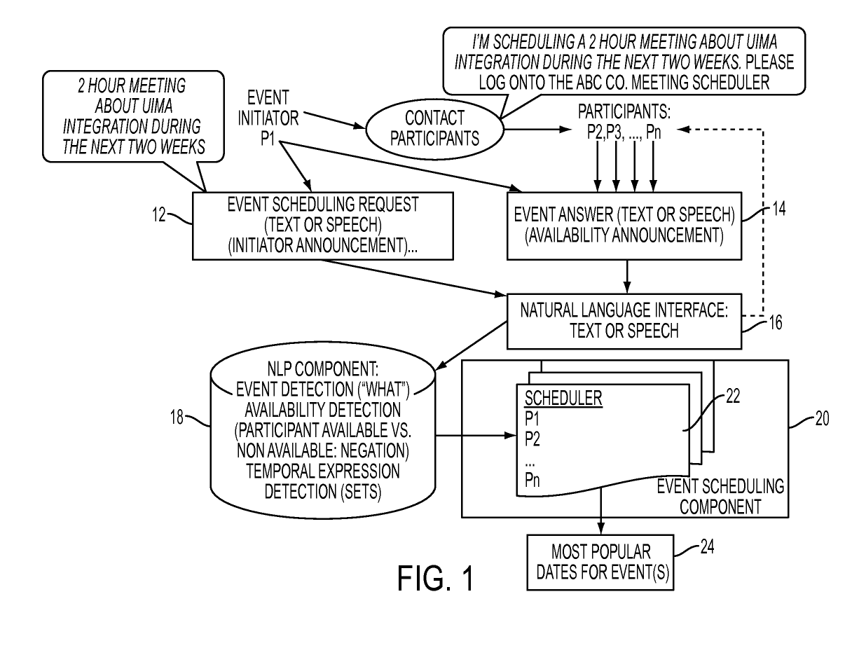

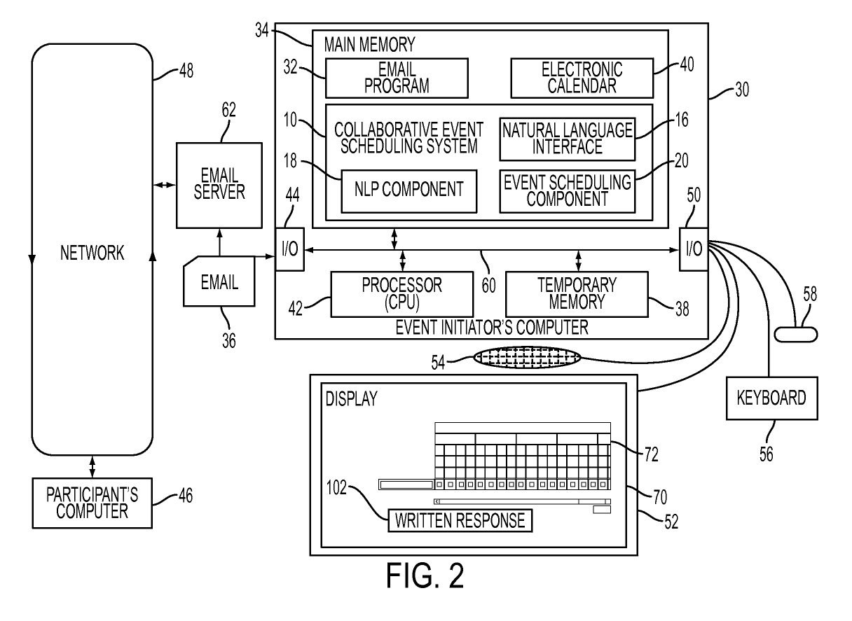

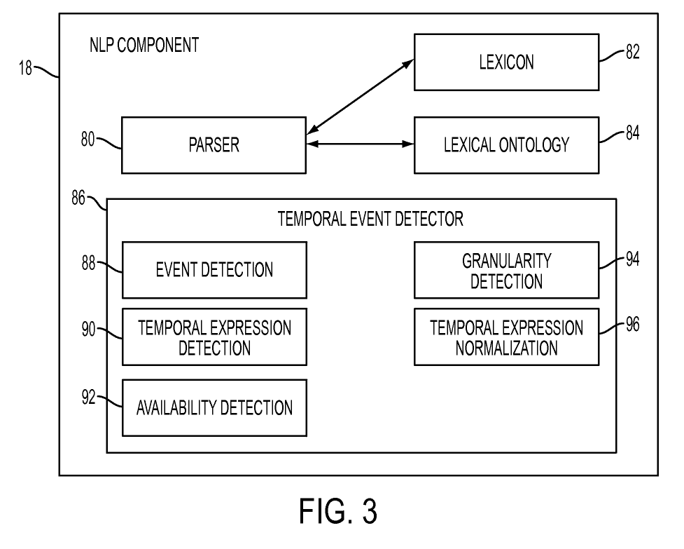

FIG. 1 illustrates an overview of an exemplary event scheduling process which may take place in the context of a networked environment hosting a collaborative event scheduling system 10, as shown in FIG. 2. An event initiator P1 wishes to schedule an event, such as a meeting, conference call, social event, or the like within a specified time period. The initiator generates an event scheduling request 12 including an initiator announcement (IA) in the form of text or speech, which is sent to the system 10. The initiator P1 may also contact other selected participants P2, P3, P4, . . . PN, to let them know that the event is being scheduled, e.g., by email, telephone, or other means of communication. The selected participants respond with an event answer 14, via text or speech, e.g., via accessing a link to a web page hosted by the event scheduling system 10. The event scheduling request 12 and event answer 14 are received by a natural language interface 16 of the event scheduling system 10 and processed by a Natural Language Processing (NLP) Component 18, which is described in further detail below with reference to FIG. 3. In particular, the NLP component analyzes, normalizes, and interprets the participants' sentences/utterances expressing their availabilities.

Information extracted from the event scheduling request 12 and event answers 14 concerning the participants' availability/unavailability within the time period is output by the NLP component 18 and is input to an event scheduling component 20. The scheduling component 20 instantiates a new displayable scheduler 22 comprising a data structure, such as a table, indicating the participants' availabilities in a sequence of time intervals during the specified time period. From this, an optimal time or times 24 can be selected, either automatically by the event scheduling component 20, or manually, by the organizer, and output to the various participants.

FIG. 2 illustrates an environment in which the exemplary collaborative event scheduling system 10 operates. The event scheduling system 10 may be hosted by a computing device 30, such as one or more general purpose computing devices or dedicated computing device(s), such as a desktop computer, laptop computer, server computer, personal digital assistant, cell phone, or other computing device, which serves as an event scheduling system. The computer 30 hosts an e-mail program or mailer 32, stored in memory 34, which contains computer program instructions for implementing an electronic mail application for creating and sending electronic mail messages 36 and attachments. Electronic mail applications are well known, such as Microsoft Outlook™ and Netscape Messenger™ systems. Incoming and outgoing electronic messages 36 may be stored in temporary memory 38 during processing by the system 10.

In one embodiment, the system 10 is wholly or partly resident on an event initiator's computer. For example, the event scheduling system 10 may serve as a plug-in software component to the mailer 32 or an electronic calendar 40. In other embodiments, the event scheduling system 10 may be at least partly resident on a server in communication with a user's computing device, and may be accessed by invited participants, for example, via a web page hosted by the server.

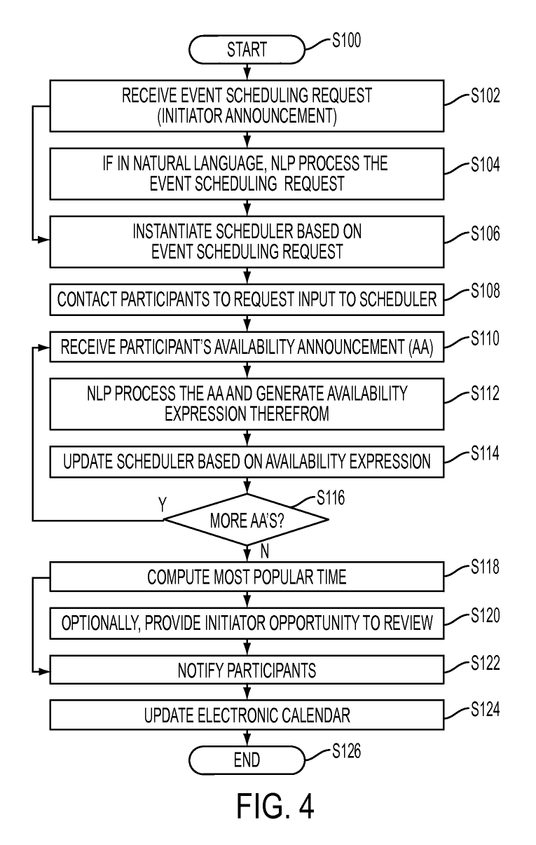

The event scheduling system 10 may be embodied in hardware, software, or a combination thereof. In the illustrated embodiment, the system 10 comprises processing instructions, stored in memory 34, which are executed by an associated processor 42. In particular, the processor 42 executes computer program instructions stored in memory 34 for implementing at least a part of the exemplary event scheduling method described below with reference to FIG. 4. A network interface 44 allows the computer 30 to communicate with other devices, such as an exemplary participant computer 46, via a computer network 48, and may comprise a modulator/demodulator (MODEM). A user input/output interface 50, may communicate with one or more of a display 52, for displaying information to users, such as an LCD screen or computer monitor, speakers 54, and a user input device, such as a keyboard 56, key pad, or touch or writable screen, for inputting text, and/or a cursor control device 58, such as mouse, trackball, or the like, for communicating user input information and command selections to the processor 42. The components 34, 38, 42, 44, 50 of the computing device 30 may communicate via a data/control bus 60.

The processor 36 may comprise the computer's CPU or one or more processing devices, such as a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, or PAL, or the like. In general, any device, capable of implementing a finite state machine that is in turn capable of implementing the flowchart shown in FIG. 4, can be used as the processor.

Computer-readable memories 34, 38, which may be combined or separate, may represent any type of computer readable medium such as random access memory (RAM), read only memory (ROM), magnetic disk or tape, optical disk, flash memory, or holographic memory. In one embodiment, the computer memory 34, 38 comprises a combination of random access memory and read only memory. In some embodiments, the processor 42 and memory 34 may be combined in a single chip.

The network 48 may include any type of wired or wireless network suitable for communication between computing devices 30, 46, such as the Internet, a local area network, a corporate data network, telephone line, or the like. The network serves as an electronic conduit for electronic messages. In some embodiments, the network 48 may include multiple levels or branches. For example, the network 48 may include at least one corporate local area network (LAN) that also links the LAN users with the Internet via a suitable firewall or other security mechanism. Although not illustrated, the network typically interconnects a number of users, for example all employees of a corporate network, all customers of an Internet Service Provider (ISP), users from around the world in the case of the Internet, or so forth, who selectively exchange email messages.

An email server 62 is operatively connected with the network 48 and the computing device 30 to route incoming and outgoing email messages. The email server 62 may route email messages for a number of users, such as P1, P2, P3, . . . PN. As will be appreciated, participant P2's computer 42, and those of other participants linked by the network 48, may be similarly configured to computer 30, optionally with a collaborative event scheduling system analogous to system 10, and need not be described further.

A user, such as the example event initiator P1, manages his or her email using the mailer 32, which is operatively connected with the email server 62. The user interacts with the mailer via a GUI 70 hosted by display 52 operatively connected with the computer, and one or more of the user input devices 56, 58, allowing the user to view an event scheduling table 72 displayed by the scheduler as well as compose and send electronic messages and receive and view incoming electronic messages.

As previously noted, the collaborative event scheduling system 10 includes the natural language interface 16, NLP component 18, and event scheduler 20. The natural language interface 16 extracts text from the electronic message content or input via a web browser. Or in the case of a voice message, converts the message to text. A voice-to-text message converter is a software application operable to convert messages from audio-based messages to text. For example, a message converter may be a speech-to-text software application, such as the DragonNaturallySpeaking® application available from Nuance, Burlington, Mass.

The NLP component 18 extracts information relating to an event from an IA or AA, as well as the participant's availability/unavailability, and the relevant time periods for the availability from an AA. As shown in FIG. 3, NLP component 18 includes a parser 80, with a natural language grammar, which performs natural language processing of the extracted textual content of the electronic mail message 36, or text input via a web browser, or speech-to-text converted text. The exemplary parser 80 has access to a lexicon 82 and a lexical ontology module 84 in an appropriate language, such as English or French. Lexicon 82 indexes words according to their parts of speech. A part of lexicon 82, or a separate lexicon, indexes words which are classed as event topic words. In particular, lexicon 82, which may be in the form of finite state transducers, indexes a set of words which are classed as representing event topics (words like “meeting,” “appointment,” etc.) allowing these to be tagged in the parsed AA or IA text as “event” words. Optionally, a lexical ontology 84 indexes named entities according to their type, in particular PERSON, ORGANIZATION, and LOCATION named entities. Lexicon 82 and lexical ontology 84, where present, may be stored in memory 34 or elsewhere, such as on a remote server which is accessed, e.g., via the Internet. The parser 80 tags the message text with tags based on the information provided by the lexicon 82 and lexical ontology 84. Syntactic parser

The event scheduling system 10 relies on natural language processing (NLP) techniques to identify linguistic elements in a text string, such as a sentence, in a natural language, with a grammar, such as English. Parsing generally involves identifying words as a sequence of tokens and associating words with information. This function is performed by the parser 80. The parser takes a text document as input and breaks each sentence into a sequence of tokens (linguistic elements) of the type described above. The parser provides this functionality by applying a set of rules, called a grammar, dedicated to a particular natural language such as French, English, or Japanese. The grammar is written in the formal rule language, and describes the word or phrase configurations that the parser tries to recognize. The basic rule set used to parse basic documents in French, English, or Japanese is called the “core grammar.” Through use of a graphical user interface, a grammarian can create new rules to add to such a core grammar. In some embodiments, the syntactic parser 80 employs a variety of parsing techniques known as robust parsing, as disclosed for example in Salah Aït-Mokhtar, Jean-Pierre Chanod, and Claude Roux, “Robustness beyond shallowness: incremental dependency parsing,” in special issue of the NLE Journal (2002); above-mentioned U.S. Pat. No. 7,058,567; and Caroline Brun and Caroline Hagège, “Normalization and paraphrasing using symbolic methods” ACL: Second International workshop on Paraphrasing, Paraphrase Acquisition and Applications, Sapporo, Japan, Jul. 7-12, 2003 (hereinafter Brun and Hagège). These example natural language processing techniques are well suited for analysis of e-mail content which can sometimes be grammatically informal or can use a telegraphic style that does not employ grammatically complete sentences and paragraphs. In one embodiment the syntactic parser may be based on the Xerox Incremental Parser (XIP), which has been enriched with additional processing rules to facilitate the extraction of references to events and temporal expressions. Other natural language processing or parsing algorithms can be used.

The incremental parser 80 incorporates a pre-processing stage which handles tokenization, morphological analysis and part of speech (POS) tagging. Specifically, the parser breaks the input text into a sequence of tokens, each generally corresponding to a text element, such as a word, or punctuation. Parts of speech are identified for the text elements, such as noun, verb, etc. Some tokens may be assigned more than one part of speech. The tokens are tagged with the identified parts of speech.

A surface syntactic analysis stage consists of chunking the input to identify groups of words, such as noun phrases. A deeper syntactic analysis performs first a simple syntactic dependency analysis and then a deep analysis. In this step, the parser may also identify syntactic relations between text elements, such as between words or groups of words, such as a subject-object relationship, an object-verb relationship, and the like. The exemplary XIP parser extracts not only superficial grammatical relations in the form of dependency links, but also basic thematic roles between a predicate (verbal or nominal) and its arguments. For syntactic relations, long distance dependencies are computed and arguments of infinitive verbs are handled. For example, the parser may identify syntactic relations between text elements, such as between words or groups of words, such as a subject-object relationship, an object-verb relationship, and the like. See (Brun and Hagège) for details on deep linguistic processing using XIP. The deeper syntactic analysis performs first a simple syntactic dependency analysis and then a deep analysis.

A temporal event detector 86 examines the output of the parser 80. In one embodiment, the temporal event detector may be integrated into the parser, e.g., as a set of additional rules applied on top of the normal grammar rules. The exemplary detector 86 includes an event detection module 88, which identifies the event which is the subject of the IA or AA. A temporal module 90 extracts temporal expressions and an availability detection module 92 identifies the modality of an AA, e.g., whether the participant's announcement expresses availability or unavailability. A granularity detection module 94 detects the granularity of the event timeline and/or the participant's answer. Once identified, the temporal expressions and availability expressions can be further processed by a normalization module 96 to extract the temporal/availability information they contain (such as inferring that “tomorrow” refers to the next date on the calendar after the e-mail's sent date or inferring that “I'm free,” means the participant in question is available). The normalization module organizes the information into a representation of the participant's availability in the form of a normalized availability formula suitable for inputting to the scheduler 22.

The event scheduling component 20 receives as input the information extracted by the temporal event detector 86 and either instantiates a new event scheduler 22 e.g., in the form of a table or other data structure, if the IA message is from the initiator, or inputs the participant information as a row of the table, if the AA message is from an invited participant.

The exemplary event scheduling component 20 takes into account the detected granularity of the time period to adapt the time boundaries automatically. By granularity, it is meant how fine the event timeline is divided or how finely the participant's time period is expressed. For example, organizing a one week-class during the next two months is different, in its granularity, from organizing a one-hour meeting during the next two weeks. In the first case, the left (starting) time boundary corresponds to the next full week from the date on which the scheduling request is initiated. The right (ending) time boundary is that day+2 months. The granularity of time divisions is expressed in weeks, with the smallest time interval being one week (or five working days). In the second case, the left time boundary of the event scheduler corresponds to the day on which the scheduling request is initiated and the right time boundary is that day+2 weeks. The time granularity of the event scheduler for this case is expressed in both days and hours (the length of the event).

By way of example, the participant may express his availability in an AA as a sentence or phrase, such as “for the next quarter, I can take the course every Monday afternoon anytime or every Tuesday morning from 10 to 11”. Expressing availability in natural language can also be more concise in cases such as “I'm available every day,” where this short assertion is equivalent to ticking a wide range of possibilities along a timeline.

In one embodiment, a speech analysis component (not shown) optionally enables the event scheduler 22 to be updated by phone. Moreover, by using speaker recognition techniques, the collaborative event scheduling system 10 may detect who the speaker is, analyze the speaker's availabilities and automatically fill in the scheduler. This may be usefully applied at the end of a phone conference or a meeting, when future meetings dates are often discussed by the different participants.

While the exemplary system 10 is illustrated as being physically located on a single computing device 30, it is to be appreciated that one or more components 10, 32, 40, and/or subcomponents of the system 10 may be remote from one another, e.g., on a client and server.

FIG. 4 illustrates a scheduling method which may be performed in the exemplary environment of FIG. 2. The method begins at S100.

At S102, an initiator submits an event scheduling request, which is received by the interface 16 of the system 10.

At S104, if the initiator's event scheduling request is in natural language form, an initiator announcement (IA) is extracted and processed by the NLP component 18.

Alternatively, if the event initiator has instead selected to enter his availabilities for the event in a timeline, the initiator may enter this in time windows in drop down menu at S102 and S104 may be omitted.

At S106, the information extracted from the event scheduling request, including the event and a time period for the event, is sent to the scheduling component 20 which instantiates a new scheduler 22 for the event.

At S108, the event scheduling request is communicated to the participants. In one embodiment, the initiator may contact participants, e.g., by phone or email, with information about the event and ask them to respond with their availabilities. Alternatively or additionally, the system may send out an automated event scheduling request, based on the information extracted from the processed IA at S104.

At S110, an invited participant responds to the event scheduling request with an availability announcement, which is received by the system 10.

At S112 the AA is processed by the NLP component to generate a normalized availability expression (e.g., a formula) in a format understood by the scheduling component 20. The availability formula expresses the participant's availabilities within the time period identified from the event scheduling request.

At S114, the participant's availability/unavailability, as determined in S112, is submitted to the scheduling component 20 which updates the scheduling table 22.

If At S116, more AA's are received, steps S110-S114 are repeated for each availability announcement.

At S118, the most popular time for the event is determined and output by the scheduler. Where two times are equally popular, the earliest time may be proposed to the event initiator and/ or all participants. Constraints may be input to the system, such as the time selected should be available for at least all the “required” participants, or only times convenient to person X are to be considered.

At S120, the event initiator may be given an opportunity to make modifications based on a review of the timeline.

At S122, if the initiator accepts the candidate scheduled time, a calendar entry may be automatically generated and used to update the initiator's calendar. At S124, the participants may be notified, e.g., an email may be automatically sent by the system to the other participants and at S126, the information may be used to update the participants' calendars. The event(s) may be automatically stored within the participant's calendar system. Alternatively, the participants may access the scheduler via the web browser to see what time has been selected or the initiator may check and send a meeting announcement to the participants.

The method ends at S1 26.

Further details of the system and method now follow.

### Availability Announcements

Each AA (and similarly for an IA) is parsed to identify the words it contains and information is associated with those words through accessing lexical resources, such as lexicon 82.

Temporal expressions are identified in the parsed text. These may be extracted by applying a set of temporal expression rules to the parsed text which are capable of extracting a variety of commonly used temporal expressions. The application of such rules by temporal expression module 90 may be analogous to that described for example, in above-mentioned U.S. Pub. No. 2007/0168430 and Tannier, et al.

Once identified, these can be compared with the shedule to associate them with particular time periods.

In addition to temporal expressions, the availability announcement further includes one or more “availability expressions” (AEs), which may be syntactically linked (by application of one or more of the parser's grammar rules) to one or more of the temporal expressions. As used herein, an availability expression can be any information which refers to the participant's availability, i.e., whether the participant is available or not. Exemplary availability expressions include “I'm free,” “I can't come,” “I won't be available,” “I'm out of the office”, and the like.

These expressions are also extracted and used to determine the participants availability for the time periods identified from the temporal expressions.

Exemplary AAs which a participant may provide can be very varied, such as:

a) I have a class on Monday

b) I can't come to the meeting unless its on a Tuesday or a Wednesday afternoon

c) We can meet on the 20^{th} or 25^{th} of January

d) Next week or the week after would be good.

e) Friday afternoon at 3 p.m. is OK for the management teleconference but I will not be able to attend the business group lunch if its next week.

In the above examples, the AE is italicized and TE is underlined.

The temporal module automatically detects these expressions within the different sentences in the text content of the AA. The detected expressions are then passed to the temporal expression normalization module 96. This module computes the actual date corresponding to these expressions. The exemplary event scheduling system 10 always takes as an assumption that the date in the text content is in the future relative to the sent date of the message.

Event topics are also identified, such as those shown in bold in the exemplary sentences above. Event topics, as used herein, can be text elements referring to meetings, appointments, etc. The definition of what is considered to be an event topic may depend on the application. Identifying the event topic may be relevant where more than one event is being discussed in availability announcement (such as example e) above).

In the case of an email message, the AA or IA can be considered to include the body of the e-mail, the e-mail header, optionally, any attachments, or a combination thereof. If the user accesses the scheduler, the scheduler automatically detects the participant's name and the time at which the participant enters his or her availability announcement.

The exemplary event scheduling system 10 provides several advantages. The participant does not have to review and tick every possibility on the schedule. Rather, the participant's availabilities can be expressed in natural language format, if this is more convenient. This provides an effective, convenient, and user-friendly method of scheduling, especially in the case where the event may take place during a lengthy time period.

While the invited participant may also be given the opportunity to respond by checking time periods in a timeline, he may often find it easier to simple provide a natural language response.

### Event Initiation

The event initiator is the person who defines the event and time window, as well as the invited participants. The event and time window can be conveyed by an Initiator announcement (IA). The IA can be a natural language expression as for the AA, but in this case, the IA includes an event expression and temporal expression which identifies the time window for the event (the period or periods in which the event can be scheduled) and the event length. An initiator announcement may be as follows:

Please identify your availability within the next two months for a two day conference entitled Event Scheduling. Alternatively, the initiator may generate a timeline by selecting options from a drop down menu.

### NLP Processing of AAs and IAs

AAs and IAs may be analyzed according to the following procedures:

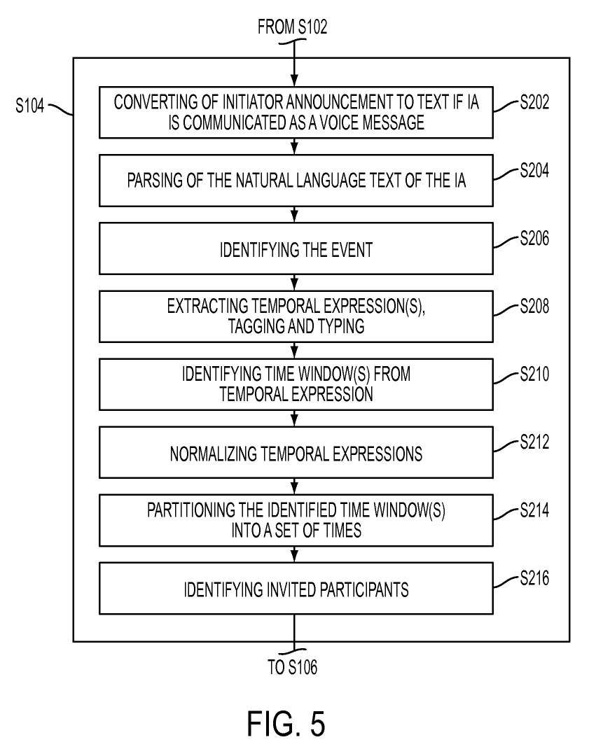

Step S104 (IA processing) may include the following substeps (FIG. 5):
S202: converting of the IA to text, if the initiator announcement is communicated as natural language voice transmission.
S204: parsing of the natural language text IA.
S206: identifying the proposed event.
S208: extracting temporal expression(s) from the IA, and tagging and typing them.
S210 identifying granularity for time window(s) from temporal expression.
S212 Normalizing TEs
S214 Identifying a time period of availability for the event in which identified time window(s) are partitioned into a set of time periods.
S216 identifying invited participants.

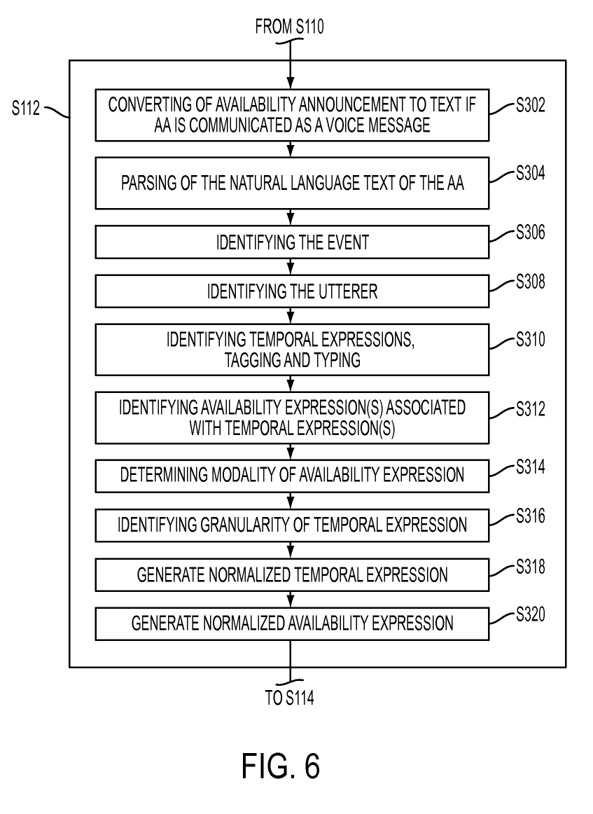

Step S108 (AA processing) may include the following substeps (FIG. 6):
S302: converting the AA to text if the AA is not in text format.
S304: parsing the text of the AA.
S306: identifying the event topic. This includes determination of the event and corresponds to the identification of the event provided by the initiator, and that needs to be calendarized.
S308 identifying the utterer as a participant- if the participant enters his AA via the scheduler, the scheduler may automatically detect the participant; if the AA is an email, the participant can be easily identified as being the sender; if a voice message, it may involve matching the sender's phone number with the utterer, or using voice recognition to identify the utterer;
S310: extracting one or more temporal expressions from the AA, and tagging and typing them.
S312: extracting an availability expression(s) from the AA associated with the temporal expression(s).
S314: determining a modality (e.g., availability or unavailability) for the time period identified from the associated temporal expression based on the availability expression.
S316: identifying granularity of the time period identified from the associated temporal expression.
S318 normalization of the temporal expression, in relation to the time period identified from the initiator's event scheduling request and/or the time/date on which the AA was submitted.

S320: generating a normalized availability expression for the participant, based on the extracted modality, time period, and granularity.

Steps S208, S210 and S310, S316 may include tagging and typing all nuclear temporal expressions (TEs) appearing in the IA and AA, respectively. For these step, only recognition, type, and granularity determination of basic TEs are performed. Normalization of the TE may be performed at S318. Step S314 includes detection of the modality expressed in the AA (i.e. available versus non available in the context of our application). This step may include an analysis of the utterance modality, i.e., whether the user expresses his availability or unavailability in the utterance. More precisely, linguistic problems as uncertainty and negation may be solved at this stage. For instance, if a participant says, “I can't on Monday but on Tuesday,” the system should detect that although “Monday” is a TE expressed in the text, this date is not considered possible for the user.

Step S318, temporal expression (TE) normalization, may include normalizing all temporal expressions. From the natural language time expressions detected in S310, calendar values are calculated. (For example, if today's date is Dec. 10, 2010 (Dec. 10, 2010), “next Monday,” will be translated into the next subsequent Monday, i.e., Dec. 13, 2010). Where no date is specified, the calendar values are determined in relation to the time period set by the initiator's event scheduling request, such that “I'm available on Tuesday” is assigned a calendar date which is a Tuesday within the time period, and where there is more than one Tuesday, may be assigned the calendar date of only the first Tuesday in the time period. Similarly, “I'm available on Tuesdays” is assigned all calendar dates which are Tuesdays within the time period. M

S320 include merging of the determined user's modality and normalized TE to obtain a representation of the user's availability over the time period in a format which is understood by the scheduler. For example, the representation is in the form of an availability formula (an expression which defines the participant's availability /unavailability over the selected time period). The availability formula is used to feed the scheduler. This step thus results in combining information extracted at S316 with information extracted at S318.

Further details on these IA and AA processing steps will now be provided.

### Event's Identification (For the Initiator Announcement)

The event's identification may include analyzing the IA produced by the initiator to detect the event proposed (S206). Event detection in natural language processing can be performed with a variety of techniques, some of which are discussed in above mentioned Tannier, et al., incorporated by reference herein. Similar techniques to those used for named entity recognition can be applied. In particular, the lexicon 82 stores a set of words indexed as “event” words, and the parser applies an event tag to the word or words in the IA identified by the lexicon as event words. Starting from this point, this event is the current event for all participants.

### Tagging and Typing of Nuclear Time Expressions

The tagging and typing of TEs (S208, S310) may be performed using a method similar to that outlined in the TimeML standard for representing temporal expressions (see Sauri, R., Littman, J., Knippen, B., Gaizauskas, R., Setzer, A., Pustejovsky, J.: TimeML Annotation Guidelines (2006), available at www.timeml.org/site/). In addition to the tagging and typing, a granularity of the TE is also determined (S210, S312).

Two main types of temporal expression are of particular interest to the present application: A) basic and B) frequency, which are described below. The temporal granularity of the event is also considered.

Types of TEs which are Detected and Typed by the NLP System 18:

A) Basic types of Temporal Expressions. Basic types may include the following subtypes:

i) Absolute dates: these are TEs of the kind “Oct. 5, 2008”. These kinds of dates can be calendarized in straightforward way. The time granularity of absolute dates is generally either day (e.g., Oct. 5, 2008) or hour of a day (e.g., Oct. 5, 2008 at 15:00). A date which has a granularity which is day corresponds to an interval starting at 00:00 of that day until 24:00 of the same day. Oct. 5, 2008 can thus be represented by an expression of the kind 2008-10-05H00:00-24:00 (which means the interval starting at 00:00 and ending at 24:00 of day Oct. 5, 2008) However, certain constraints may be placed on the time interval corresponding to day, such as normal business hours, e.g., 2008-10-05H08:00-18:00.

ii) Referential dates with reference to the Announcement Time

This kind of TE corresponds to expressions like “Monday,” “next Monday,” “next Month/week,” “October 5^{th},” etc. As absolute dates, they correspond to a calendar point, but to normalize them requires a referential point, which is considered to be the time of the announcement. Such temporal expressions can have different granularities. For example, “Next Monday” has the granularity “day,” while “next month,” has the granularity “month,” etc. As for the case of absolute dates, the absolute day of granularity “day” may also correspond to an interval from the first moment of that day until the last moment of that day.

iii) Durations: These are simple TEs denoting a time period, for instance, “all week,” “during the next year”. As for date expressions, the expressions can also have different granularities (day, week, etc.)

iv) Intervals: these expressions also denote duration where explicit time boundaries are expressed. Intervals can be calendarized. For instance “from 10:00 to 12:00” is an interval of granularity “hour.” “From Monday to Wednesday” is an interval of granularity “day” with referential dates as boundaries. “Between October 5^{th} and October 10^{th}” is an interval of granularity day with absolute dates as boundaries.

B. Frequencies as types of Temporal Expressions: Frequencies are sets of the basic types presented above. For example, “every Monday” is a frequency of referential dates and will correspond to the set of all Mondays starting from the following Monday (taking again as reference the Announcement moment).

In step S208, S310 all basic TEs that are present in the IA/AA are tagged, and typed according to the categories presented above.

### Time Granularity

At S210, S312, a granularity is associated to the tagged and typed TEs. The granularity which may suitably be considered can be selected from “year”, optionally, fractions of year, such as quarter year, “month”, “week”, “day”, “morning”, “afternoon,” “hour,” and optionally fractions of hour, such as quarter hour intervals or ten minute intervals.

This can be illustrated by the following example:
AA: I am free every Monday during the next quarter.

Two basic TEs are extracted: “every Monday” and “during the next quarter.”

The first one (TE1) is typed as “frequency of referential dates”, and the associated granularity is “day”. The second one (TE2) is typed as “duration” and the associated granularity is month (as a quarter corresponds to 3 months). Determination of Invited Participant's Availability

S312 includes determining an expression of the availability of the user (invited participant). In order to achieve this task satisfactorily, the analysis of three main aspects may be considered: negation, connection, and modality.

As an example, participant P2 expresses the following AA: “I'm free every Monday but not between 10:00 and 12:00.” In this AA, the expressed modality is the one of availability: “I'm free”. There are two temporal expressions: “every Monday,” with a granularity of “day” and “between 10:00 and 12:00,” which has the granularity of hour and which is negated. The connection between them is expressed by the coordination conjunction “and.”

As a first step in generating an availability formula, the following intermediate representation may be generated:

P2: available (TE1-date_frequency-granularity(day)) and

not_available(TE2-interval-granularity(hour))

Assuming that TE1 and TE2, corresponding respectively to “every Monday” and to “between 10:00 and 12:00 are recognized as TEs and typed correctly, they can be normalized for the next step.

Suppose now the following AA is uttered by P3: “I'm free on Monday but not on Tuesday.” An intermediate representation can be generated as follows:

P3: available(TE3-date_point-granularity(day)) and

not_available(TE4-date_point-granularity(day))

In these two examples, the surface expressions are similar. But in the first case, as the granularity of negated TE2 is “hour” and the granularity of non negated TE1 is day, the second expression (TE2) is considered to be dependent from the first one (TE1). In other words the non_availability expressed by the hour interval TE2 applies to TE1.

In the second case, both TE3 and TE4 have the same granularity, so in this case, there is no dependency inferred between TE3 and TE4.

As a result, the final availability formula for participant P2 will be:

P2: TE1-TE2 (i.e., TE1 minus the time denoted by TE2)

While for P3 it will be:

P3: TE3 AND NOT(TE4) (i.e., a conjunction of time denoted by T3 and negation of time denoted by TE4.

Concerning modality, a finite range of expressions can be encoded. In the exemplary embodiment, the modality has two possible values: “available” and “not available.” However, in other embodiments, additional values could also be contemplated, such as “don't know”, which could be treated as “unavailable,” for the purposes of scheduling, unless no other time period is returned as available for all participants.

For example an AA such as “I'm not sure for Monday” is accorded the modality not available, resulting in an intermediate expression such as:

P4: not_available(TE1-date_ref-granularity(day))

The system 10 may store a range of expressions in lexicon 82 corresponding to each modality value. For example, for the modality availability, the following expressions: I'm free, it's OK, it works for me, it is fine for me, I can etc. will be translated into “available” while expressions such as “probably not freelavailable”, “I'm unavailable”, “I'm booked”, “I'm not sure I can/to be free/to be available, I can't” etc. will be translated into “not_available”.

Concerning connection, the system may store a set of NL connectors that may appear in AAs, and associate each with an equivalent defined for the construction of the formula.

For example, “and” corresponds at a first approximation to “and” in the intermediate formula which finally can give either an & or a—connector taking into account the granularity of coordinated expressions.

A connector such as “but only” appearing in “TE1-granularity1 but only TE2-granularity2” is translated in the intermediate formula into TE1 at TE2 if granularity1>granularity2

As an example, for an AA like “I'm available on Monday but only from 10:00 to 12:00” the following intermediate formula can be generated:

P4: available (TE5-date_point-granularity(day)) at TE6-interval-granularity(hour)

A connector “but not” may be treated as “and not”.

As will be appreciated, some expressions may be adapted to fit with the construction rules. For example, an expression like “I'm free on Monday but at 10:00 only” where the connector is “but only” is surrounding the temporal interval can be converted to an equivalent, such as “I'm free on Monday at 10:00.” Another kind of expression that may also need to be adapted includes expressions like: “I can on Monday but on Tuesday I have another meeting” which can be replaced by “I can on Monday but not on Tuesday.” Additionally, expressions like “At any time except TE” that correspond to the complementary of the temporal expression denoted by TE can be represented by Comp(TE).

### Temporal Expression Normalization

Basic TEs have been tagged, typed and granularity associated. In S212, S318, the normalization of the TE is performed. Here, normalization means analysis of the TE in order to obtain a representation that can be calendarized.

A similar approach to the one proposed in TimeML (Markup Language for Temporal and Event Expressions) for the normalization of TE, which have been already tokenized and typed in S208, S310 may be used. In the exemplary embodiment, normalization techniques analogous to those described in Tannier, et al., may be used.

For example, using a TimeML like representation, the result of normalization may be:

<TIMEX3 tid=“t1” type=“SET” value=“xxxx-wxx-1” quant=“EVERY”/>for an expression like “every Monday”, where the periodicity of “Monday” is indicated in an attribute value, while the type of quantification is indicated by keyword “EVERY” as stated in TimeML. Such an expression is an aggregate of temporal expressions (as indicated by the attribute “type” which has the value “SET”). Quantification of this aggregate is expressed by the keyword “EVERY” (value of “quant” attribute) and periodicity of this quantification is represented by the normal form “xxxx-wxx-1” which means “first day of the week” (i.e. “Monday”).

An expression <TIMEX3 tid=“t2” type=“DATE” value=“2009-10-04”/>may be used for time expressions like “October the 4^{th}”, if the underlying year is 2009.

Note that, as explained above, the TimeML notation of a time point of granularity day is extended to an interval of hours, spanning from the beginning of the day to the end of day.

Merging information to Obtain the Final Formula

In the final step of generating an availability formula (S320), all the information collected during the different processing steps is merged together, that is: Event identification extracted from the initiator announcement (S206) and modality information, together with normalization of the TEs for all participants. The following scenario illustrates the process.

Initiator: initiates a scheduler 22 for a 2 hour meeting and sends an email to all potential participants. The day the IA is sent is Dec. 2, 2008. The initiator defines a time boundary for the event which is from Monday, 8^{th} December to Friday 12th December. This assumes that any time this week is convenient for the initiator.

As the event is a meeting, and its length is two hours, the granularity of the time line is 2 hours, on a one week period (from Monday, 8th December to Friday 12th December).

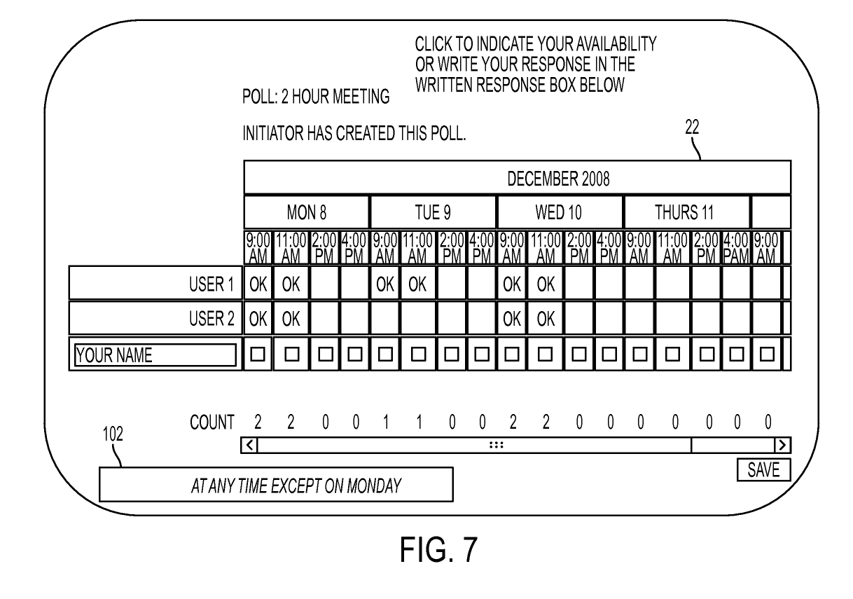

The initial scheduler 22 for the meeting may then look like that shown in FIG. 7.

User 1 replies (e.g., by typing in box 102): “I'm available the 8^{th}, 9^{th} and the 10^{th} but only in the morning”.

User 2 replies: “I'm only available on Monday morning and Wednesday morning”

User 3 replies: “At any time except on Monday.”

The different steps performed as described above enable the system 10 to extract the following availability formulae:
User 1: available(TE1) and available(TE2) and available(TE3) where
<TIMEX3 tid=“TE1”type=“DATE” value=“2008-12-08H0000-2400”/>, <TIMEX3 tid=“TE2”type=“DATE” value=“2008-12-09H0000-2400”/>, and <TIMEX3 tid=“TE3” type=“DATE” value=“2008-12-10H1200-1900”

In this case, “afternoon” is translated into a time period from 12:00 to 19:00 whereas “morning” is translated into a time period from 08:00 to 12:00. The default time for the whole day may be from 00:00 to 24:00 but this could be adapted to a shorter period, such as from 08:00 to 19:00 in the context of business meetings.
User 2: available(TE4) and available(TE5) where <TIMEX3 tid=“TE4”
type=“DATE” value=“2008-12-08H0800-1200”/>, <TIMEX3 tid=“TE5”
type=“DATE” value=“2008-12-10H0800-1200”>
User 3: available(Comp(TE6)) where <TIMEX3 tid=“TE6” type=“DATE”
value=“2008-12-08H0800-2400”/>

After having solved the value of Comp(TE6) in the time span specified by the given scheduler, the following expressions are obtained:
User 3: available(TE7) and available(TE8) and available(TE9) and
available(TE10) where <TIMEX3 tid=“TE7” type=“DATE” value=“2008-12-09H0800-2400”/>, <TIMEX3 tid=“TE8” type=“DATE” value=“2008-12-10H0800-2400”/>, <TIMEX3 tid=“TE9” type=“DATE” value=“2008-12-11H0800-2400”/>, <TIMEX3 tid=“TE10” type=“DATE” value=“2008-12-12H0800-2400”/>

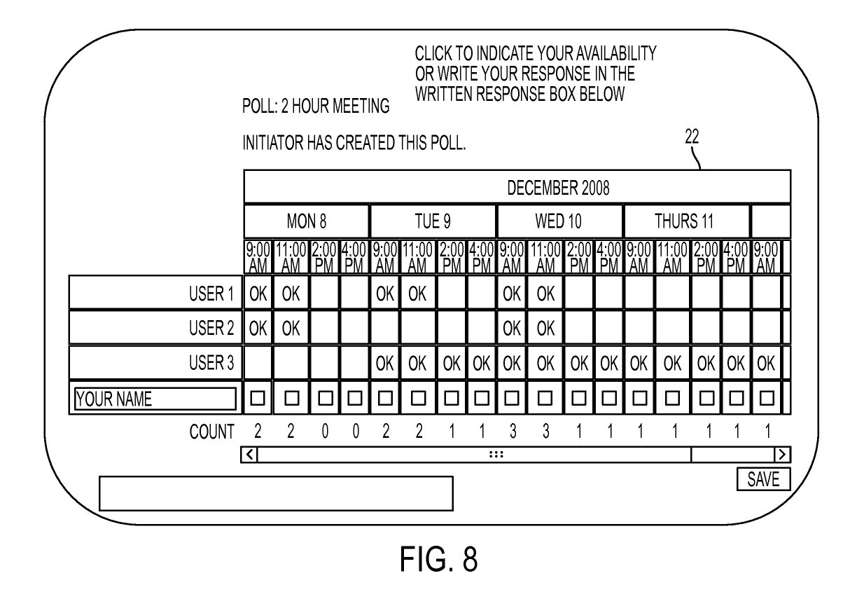

At the end of this process, the scheduler 22 is fully updated (FIG. 8). In the present case, the best times that will be computed are Wednesday December 10^{th}, at 9 am or 11 am.

While the examples given consider only a single event, it is to be appreciated that multiple event schedulers may be instantiated, each one corresponding to a given event. In such a case, the user (invited participant) expresses himself in natural language, and then the system detects the different events together with the availabilities expressed by the user for each event.

In the exemplary embodiment, event identification (S306) may be followed by an event normalization process: This ensures that the event extracted from an AA matches the one which is the subject of a given scheduler 22. Since a fairly limited vocabulary is being considered, comparison between two strings representing events (the one extracted from the AA and the one represented in the scheduler) can be enriched with synonymy replacement, case normalization, possible skip of preposition, and word order modification. Simple equivalences like “Noun ProperNoun” equivalent to “ProperNoun Noun” equivalent to “Noun for/of ProperNoun” can be defined. For instance, “Meeting Client” matches “Client meeting”, “Meeting with client”, “Meet the Client” etc. Furthermore, permutations of pre-defined synonyms may be considered equivalent. For example, “phone conference” may be treated as a synonym equivalent for “phone meeting”.

The exemplary embodiment provides advantages over existing schedulers by incorporation of natural language analysis (speech+text or text) with collaborative event scheduler systems. Another advantage is that the system is able to take into account the granularity of the event (duration) to automatically adapt the scheduler timeline accordingly. This may be particularly advantageous when planning a recurrent event over a year, such as, for example, classes. The linguistic component allows the system to account for negation, coordination and also provides a more precise analysis of time cycle expressions than is required for natural language processing of electronic messages for automated generation of calendar entries.

Another advantage of one embodiment is that the scheduling system may be adapted to handling several events at the same time (e.g., a participant would able to say/write something like “For the meeting in Paris I'll be available next Monday or Tuesday, and then for the phone call, from Wednesday 4 to Friday 6”, for updating several event schedulers).

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The method illustrated in FIGS. 4-6 may be implemented in a computer program product that may be executed on a computer. The computer program product may be a computer-readable recording medium on which a control program is recorded, such as a disk, hard drive, or the like. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use. Alternatively, the method may be implemented in a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, or PAL, or the like. In general, any device, capable of implementing a finite state machine that is in turn capable of implementing the flowchart shown in FIGS. 4-6, can be used to implement the event scheduling method.

Without intending to limit the scope of the exemplary embodiment, the following example illustrates an exemplary scheduling scenario.

### EXAMPLE

A person (event initiator) wants to initiate an event involving several persons. He contacts the people to warn them (by mail, phone, etc.) and then uses the collaborative scheduler by writing (or interacting orally if a speech to text component is integrated) a sentence like: “2 hours meeting about UIMA integration during the next two weeks.” This triggers an NLP analysis of the sentence detecting the topic of the event (meeting about UIMA integration), its duration (2 hours) and the time expression (during the next two weeks). This time expression is normalized and interpreted so that it can be anchored in the timeline (here: a two weeks period starting from today, divided in days and hours per days). At the same time, this time expression is the basis for the creation of appropriate time boundaries and time divisions of the scheduler. The scheduler can be then automatically created (event & timeline). Then, the participants, including the initiator, can interact in natural language to express their availabilities, for example by writing: “I'll be available only next Thursday from 10 to 12,” or “I can only on Friday 2, the whole day,” or “my availabilities are Monday 10 from 9 to 12, Tuesday 11 afternoon, and Thursday 13,” “next week any time is ok for me,” etc. Again these sentences are analyzed and interpreted in order to fill in the scheduler automatically. A standard voting procedure is associated with the scheduler in order to provide the most popular date(s).

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A collaborative event scheduling method comprising:
for each of a plurality of users:
receiving a user's availability announcement in a natural language in response to a collaborative event scheduling request for which a time for an event is to be established within a time window defined by an event initiator, based on the users' availability announcements;
based on the availability announcement, with a computer processor, generating a representation of the user's availability within the time window, including:
extracting a temporal expression from the availability announcement;
if the temporal expression is determined to be referential, normalizing the extracted temporal expression;
identifying an availability modality for each extracted temporal expression from a set of availability modalities; and
generating the representation based on the normalized temporal expression and availability modality; and
outputting the generated representation to an event scheduler for establishing a suitable time for the event within the time window based on the availability announcements of the plurality of users.

2. The method of claim 1, wherein the generation of the representation further includes, for each identified temporal expression, assigning an expression type to the expression selected from a predetermined set of expression types.

3. The method of claim 2, wherein the expression types include absolute dates, referential dates, durations, intervals, and frequencies.

4. The method of claim 1, wherein the availability modality is selected from an available modality and an unavailable modality.

5. The method of claim 1, identifying a granularity of a time period identified in the extracted temporal expression.

6. The method of claim 5, wherein the granularity is selected from the group consisting of hours, days, weeks, months, and combinations thereof.

7. The method of claim 1, further comprising parsing the availability announcement with a parser which applies grammar rules to identify words in the availability announcement.

8. The method of claim 7, wherein the parsing includes accessing a lexicon which stores a set of words which are indexed as event words, whereby the user's availability announcement is associable with the event.

9. The method of claim 1, wherein the normalization of the temporal expression is based on at least one of the time window and a time at which the response was submitted by the user.

10. The method of claim 1, wherein the normalization of the temporal expression wherein the normalization of the temporal expression assumes that all temporal expressions relate to future time periods.

11. The method of claim 1, wherein the identifying of an availability modality includes extracting an availability expression associated with the temporal expression and determining an availability modality based on the availability expression.

12. The method of claim 1, wherein the availability announcement comprises at least one of a spoken availability announcement and a text availability announcement.

13. The method of claim 1, further comprising:
receiving an event scheduling request in natural language from the event initiator; and
natural language processing of the event scheduling request to identify the event, a time window in which the event is to occur, and a granularity of a time period for the event.

14. The method of claim 13, further comprising: instantiating a scheduler based on the event, time window, and time period granularity for the event.

15. The method of claim 1, further comprising, with the scheduler, identifying a most popular time period for the event and outputting the most popular time period.

16. A computer program product encoding instructions which when executed by a computer, perform the method of claim 1.

17. A collaborative event scheduling system comprising:
computer readable memory which stores instructions for performing the method of claim 1 and a processor in communication with the memory which executes the instructions.

18. A collaborative event scheduling system comprising:
computer readable memory which stores instructions for:
receiving a user's availability announcement in a natural language to a collaborative event scheduling request for which a time for the event is to be established within a time window defined by an event initiator;
based on the availability announcement, generating a representation of the user's availability within the time window in a format understandable to an associated scheduler, including:
identifying a temporal expression in the response;
normalizing the temporal expression in relation to the time period;
identifying an availability modality associated with each identified temporal expression; and
generating the representation based on the normalized temporal expression and availability modality; and
outputting the representation to an associated scheduler; and
a processor in communication with the memory which executes the instructions.

19. The collaborative event scheduling system of claim 18, wherein the instructions for generation of the representation further include, for each identified temporal expression, instructions for assigning an expression type to the expression selected from a predetermined set of expression types.

20. A collaborative event scheduling method comprising:
receiving an event scheduling request in a natural language form which includes an event for which a time period is to be established within a specified time window;
processing the event scheduling request to identify the time window and a granularity of time periods within the time window;
receiving availability announcements from a plurality of invited participants, each availability announcement expressing, in a natural language, the respected participant's availability for the event;
based on the availability announcements, with a computer processor, generating a representation of each participant's availability within the time window, including:
extracting a temporal expression from the availability announcement; and
identifying an availability modality for each extracted temporal expression from a set of availability modalities; and
outputting a suitable time period for the event within the time window based on the extracted temporal expressions and identified availability modalities for the participants.
